(19) United States
(12) Patent Application Publication
(10) Pub. No.: US 2008/0124243 A1
(43) Pub. Date: May 29, 2008

(54) Test strip-ejecting mechanism and a device with the test strip-ejecting mechanism

(76) Inventors: Kun Sung Chen, Taipei (TW); Ying Chao Lin, Taipei (TW); Kuo Hung Huang, Taipei (TW); Kun Te Ko, Taipei (TW)

Correspondence Address: VENABLE LLP, P.O. BOX 34385, WASHINGTON, DC, 20043-9998, US

(21) Appl. No.: 11/826,329

(22) Filed: Jul. 13, 2007

(30) Foreign Application Priority Data
Nov. 29, 2006 (TW) 095144143

(51) Int. Cl. B01J 19/00

(52) U.S. Cl. 422/50

(57) ABSTRACT

This invention provides a device with a test strip-ejecting mechanism, which includes a casing and a test strip-ejecting mechanism installed inside the casing. The casing is provided with an insert opening collimated with a connector inside the casing for receiving a test strip. The test strip-ejecting mechanism includes a body provided with a guide groove and having an ejection base formed on a front end of the body, a block disposed inside the casing to define the body to slide along a predetermined direction in conjunction with the guide groove, and a spring providing the body a restoring force along the predetermined direction. The ejection base is disposed at the predetermined direction for ejecting the test strip from the connector along the predetermined direction. The present invention also provides a method for ejecting the test-strip.

### BACKGROUND OF THE INVENTION

1. Field of the Invention

The present invention relates to a test strip-ejecting mechanism, a device with the test strip-ejecting mechanism and a method thereof; more particularly relates to a test strip-ejecting mechanism for discarding a waste test strip without manual contact, a device with the test strip-ejecting mechanism and a method thereof.

2. Description of the Prior Art

As the ageing population grows fast year after year, it is imperative that expenditure on social resources should be reduced. In response to this trend, the Tele-medicine system has been adopted in different countries around the world to reduce the number of medical consultations, thereby lowering medical costs and maximizing the potential of health care. In order to record people's physiological states or health conditions, patients, family members, and medical staffs often need to use physiological sensors such as sphygmomanometers, glucosemeters and body fat analyzers etc. It results in another problem that test strips such as blood test strips used in glucosemeters must be discarded and treated properly after being used in order to prevent users from infection.

Taiwanese Patent Number 594006 entitled “Biosensor with Multi-Channel A/D Conversion and a Method Thereof” primarily includes a blood sugar-testing chip generating a time-dependent analog signal in response to a test strip provided thereon, wherein the test strip is formed by a first substrate, a second substrate and a reaction layer. An electrode is provided on a suitable location on a first face of the first substrate, and a plurality of golden fingers are provided on the other side of the first substrate opposite to the electrode. A plurality of leads extending from the electrode connects with the golden fingers of the test strip. A blood injection area is provided on the second substrate relative to the electrode of the first substrate, and blood is injected in the blood injection area during testing. The reaction layer contains a chemical composition for testing.

Referring to FIGS. 11A and 11B, which illustrate the actions of the conventional biosensor from the top view, the conventional biosensor is provided with a reaction layer attached onto an electrode of the first substrate, which is coupled to the second substrate to form a test strip 3000. The test strip 3000 is substantially in the form of a rectangle or a quadrilateral.

When users use glucosemeters, a known test strip 3000 and a testing unit 2000 are required. The testing unit 2000 is provided with a connector 2100. The known test strip 3000 is inserted into a connector 2100 disposed inside the testing unit 2000, such that golden fingers of the known test strip 3000 are inserted into a testing portion inside the connector 2100. Blood is dripping into the blood injection area of the test strip 3000. When a test starts, information generated from blood sample will be transmitted to the testing unit 2000 through the electrode, the leads and the golden fingers.

When the test is finished, the known test strip 3000 has to be discarded from the connector 2100 of the testing unit 2000. If the known test strip 3000 is manually pulled out, the possibility of contacting with the blood becomes higher, which increases the risk of infection. To protect users from being infected of blood transmitted diseases, it is necessary to provide a test strip-ejecting mechanism capable of discarding the waste test strips 3000 without manual contact, and a device with the test strip-ejecting mechanism.

### SUMMARY OF THE INVENTION

The primary object of the present invention is to provide a test strip-ejecting mechanism and a device with the test strip-ejecting mechanism to discard an used test strip without manual contact to protect users.

Another object of the present invention is to provide a test strip-ejecting mechanism, a device with the test strip-ejecting mechanism and a method thereof to discard a test strip without manual contact after the test strip in a biosensor is used so as to protect the safety of users or healthcare workers.

A further object of the present invention is to provide a test strip structure suitable for the test strip-ejecting mechanism of the present invention.

To achieve the above objects, a device with a test strip-ejecting mechanism includes a casing provided with an insert opening, which is collimated with a connector inside the casing for receiving a test strip; and a test strip-ejecting mechanism installed inside the casing, including a first assembling component with a first body, a first block and a first spring as well as a second assembling component having a second body, a second block and a second spring. The first body is provided with a first guide groove and a front end of the first body has an ejection base. The first body also has a first slanted portion. The first block is disposed in the first guide groove inside the casing to define the first body to slide along a first direction in conjunction with the first guide groove. The first spring provides the first body a restoring force along the first direction. The second body is provided with a second guide groove, and a front end of the second body has a press-button outside the casing. The second body also has a second slanted portion. The second block is disposed in the second guide groove inside the casing to define the second body to slide along a second direction in conjunction with the second guide groove. The second spring provides the second body a restoring force along the second direction. The first slanted portion abuts against the second slanted portion such that an angle is contained between the first direction and the second direction.

It is preferable that the ejection base has a pair of top abutting portions.

It is preferable that the first guide groove is provided with first through holes, and the first block is provided with a first guide shaft passing the first through holes of the first guide groove. The first spring is disposed on the first guide shaft at a side of the first block.

It is preferable that the second guide groove is provided with second through holes, and the second block is provided with a second guide shaft passing the second through holes of the second guide groove. The second spring is disposed on the second guide shaft at a side of the second block.

The present invention also provides a test strip-ejecting method, including forming an insert opening in a casing and inserting a test strip into the insert opening; forming a slidable first body inside the casing such that the first body slides along a first direction and a restoring force can be applied to the first body along the first direction; forming a slidable second body inside the casing such that the second body slides along a second direction and a restoring force can be applied to the second body along the second direction; coupling the first body with the second body such that an angle is contained between the first direction and the second direction; extending an ejection base from the first body, and making the ejection base being collimated with the insert opening such that the test strip can be ejected from the insert opening.

It is preferable that the ejection base has a pair of top abutting portions.

It is preferable that the second body has a press-button.

Additionally, the present invention provides a test strip structure with an elongated strip body having a blood injection area formed on one end thereof. A plurality of golden fingers are formed on the other end of the elongated strip body. A stopping portion is formed on each of two lateral sides of the elongated strip body proximate to the golden fingers such that when the end of the elongated strip body formed with the golden fingers is inserted into an electrical connector, a test strip-ejecting mechanism can eject the elongated strip body by pushing forward the stopping portions.

The end of the elongated strip body formed with the golden fingers is narrower than the elongated strip body. The two lateral sides of the elongated strip body being proximate to the golden fingers project outward to form a width of the elongated strip body.

It should be noted that the portions of the two lateral sides of the elongated strip body proximate to the golden fingers form stopping portions whose abutting faces are vertical to an inserting direction of the golden fingers inserting into the electrical connector.

The present invention provides a safer biosensor device and a method thereof such that the used test strips can be discarded without manual contact.

### BRIEF DESCRIPTION OF THE DRAWINGS

The present invention will become more fully understood from the detailed description given herein below and the accompanying drawings which are given by way of illustration only, and thus are not limitative of the present invention, and wherein.

FIG. 1 shows a schematic perspective view of a test strip used in a device with a test strip-ejecting mechanism of the present invention.

FIG. 2A through FIG. 2C are schematic top views illustrating actions of the test strip from being inserted into a connector of the present device to connect with the strip-ejecting mechanism and then being ejected from the strip-ejecting mechanism.

FIG. 3A is a schematic top view of a device with a test strip-ejecting mechanism of the present invention.

FIG. 3B is a schematic top view illustrating actions of the device of FIG. 3A.

FIG. 4 is a schematic view along the A-A line of FIG. 2B.

FIG. 5 is an exploded perspective view of a first assembling component of the device with the test strip-ejecting mechanism of the present invention.

FIG. 6 is an exploded perspective view of a second assembling component of the device with a test strip-ejecting mechanism of the present invention.

FIG. 7A is a schematic top view illustrating a device with a test strip-ejecting mechanism according to another embodiment of the present invention.

FIG. 7B is a schematic top view illustrating the action of the device of FIG. 7A.

FIG. 8 is an exploded perspective view of a strip-ejecting mechanism of the device of FIG. 7A.

FIG. 9A is a schematic backside view of the device of FIG. 7A.

FIG. 9B is a schematic backside view of the device of FIG. 7B.

FIG. 10 is a schematic top view of a device with a test strip-ejecting mechanism according to another embodiment of the present invention.

FIG. 11A through FIG. 11B illustrate the actions of the conventional biosensor from the top view.

### DETAILED DESCRIPTION OF THE PREFERRED EMBODIMENTS

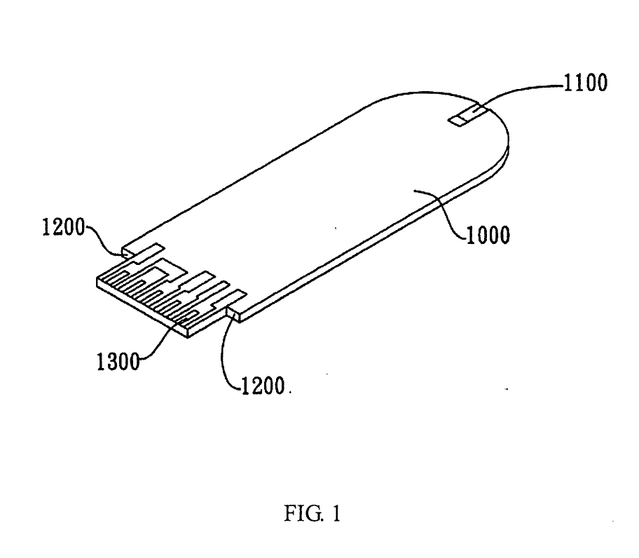

Referring to FIG. 1, which shows a schematic perspective view of a test strip 1000 used in a device with a test strip-ejecting mechanism of the present invention. The test strip 1000 has an elongated strip body with a blood injection area 1100 formed on one end thereof, and the other end of the elongated strip body is provided with a plurality of golden fingers 1300. A plurality of lead wires is provided inside the test strip 1000 for connecting the blood injection area 1100 and the golden fingers 1300. A pair of stopping portions 1200 is formed on two lateral side corners proximate to the golden fingers 1300 of the test strip 1000. The abutting faces of the stopping portions 1200 are perpendicular to the direction of the golden fingers 1300 inserted into an electrical connector. And the end of the test strip 1000 formed with the golden fingers is narrower than the test strip body. The stopping portions projecting from the two lateral sides of the test strip body form a width of the test strip, as shown in FIG. 1. When the end of the test strip 1000 formed with the golden fingers 1300 is inserted into an electrical connector, a test strip-ejecting mechanism ejects the test strip 1000 by pushing forward the stopping portions 1200 of the test strip 1000.

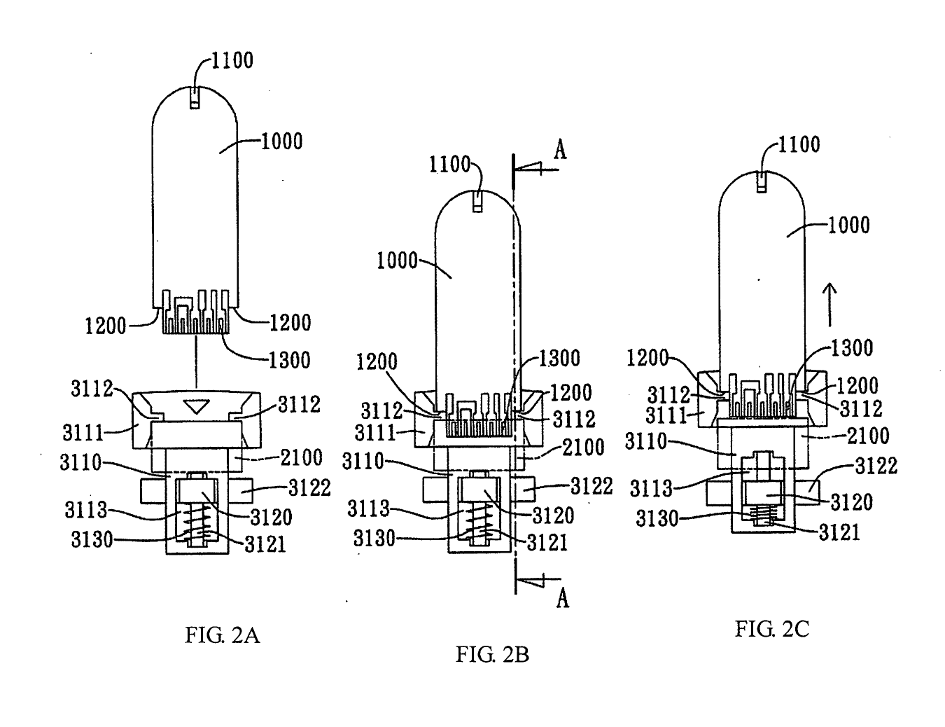

FIG. 2A through 2C illustrates actions of the test strip 1000 from being inserted into a connector 2100 of the present device to connect with the strip-ejecting mechanism and then being ejected from the strip-ejecting mechanism. When the test strip 1000 is to be used, as shown in FIGS. 2A and 2B, the test strip 1000 is inserted into the connector 2100, which is fixed on a circuit board inside a testing unit 2000. The stopping portions 1200 proximate to the golden fingers 1300 of the test strip 1000 abuts against the top abutting portions 3112 of the ejection base 3111. When the test strip 1000 is to be ejected, the test strip 1000 is pushed forward through the ejection base 3111. The top abutting portions 3112 of the ejection base 3111 push the stopping portions 1200 of the test strip 1000 such that the test strip 1000 is ejected from the connector 2100, as shown in FIG. 2C.

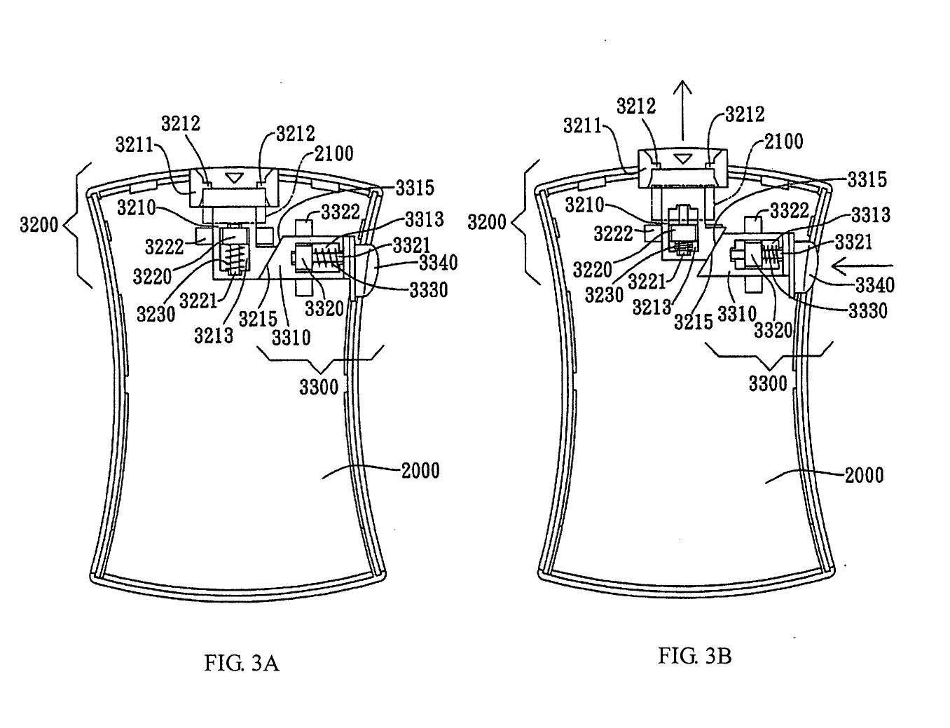

FIG. 3A is a schematic top view of a device with a test strip-ejecting mechanism and FIG. 3B is a schematic top view illustrating action of the device. An insert opening (not shown in the drawing) is formed on one end of the testing unit 2000 for receiving a test strip 1000. The test strip-ejecting mechanism is installed inside a casing of the testing unit 2000. The connector 2100 is immovably fixed on a circuit board inside the testing unit 2000. After the push-button 3340 of the test strip-ejecting mechanism is pressed with a force, the force is transferred to another direction via the second slanted portion 3315 and the first slanted portion 3215, thereby pushing the ejection base 3211 forward and ejecting the test strip 1000. The test strip-ejecting mechanism is pushed forward to eject the test strip 1000 from the connector 2100, which is fixed in the testing unit 2000.

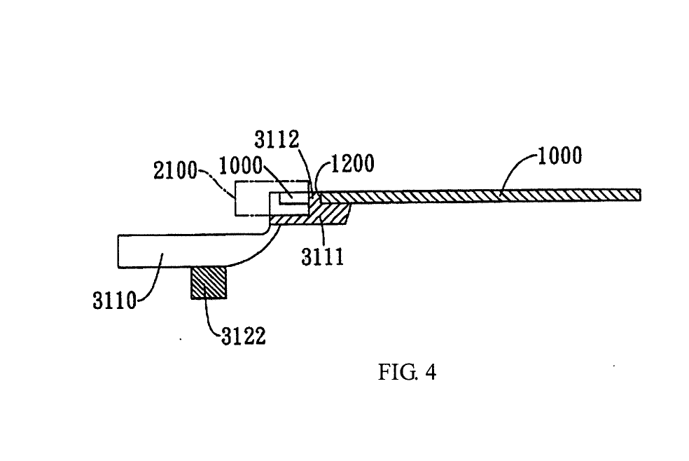

FIG. 4 is a schematic view along the A-A line of FIG. 2B. The connector 2100 is disposed on a top of the ejection base 3111. When the test strip 1000 is inserted into the connector 2100, the stopping portions 1200 abut against the top abutting portions 3112 of the ejection base 3111, as shown in FIG. 4. Please also refer to FIGS. 3A and 3B, while the connector 2100 is immovably fixed, pushing the test strip-ejecting mechanism will make the top abutting portions 3112 of the ejection base 3111 move forward resulting in ejecting the test strip 1000 from the connector 2100.

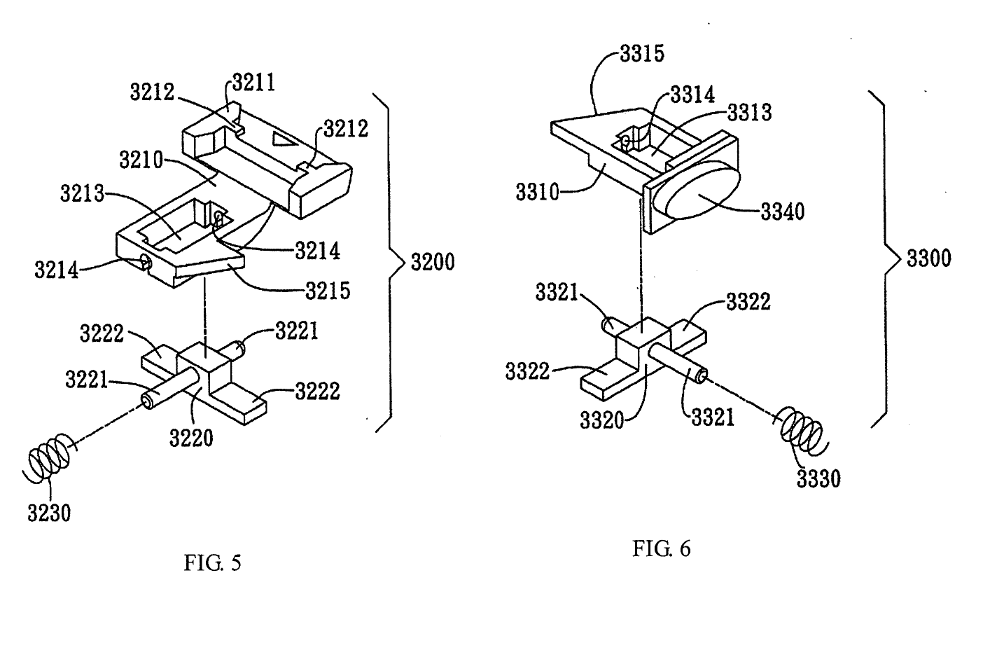

The test strip-ejecting mechanism includes a first assembling component 3200 and a second assembling component 3300. Referring to FIG. 5, the first assembling component 3200 includes a first body 3210, a first block 3220 and a first spring 3230.

A first guide groove 3213 is formed in the first body 3210. A pair of first through holes 3214 is formed in the first body 3210 and communicates with the first guide groove 3213. An ejecting base 3211 is provided on a front end of the first body 3210. A first slanted portion 3215 projects from a right side of the first body 3210. The ejection base 3211 includes a pair of top abutting portions 3212 for abutting against the test strip 1000. A guide shaft 3221 passes through an approximate middle portion of the first block 3220 disposed inside the first guide groove 3213. A first wing 3222 is formed on each of two sides of the first block 3220. The first wings 3222 are secured to a circuit board in the testing unit 2000. A first spring 3230 envelops another end of the first guide shaft 3221 of the first block 3220 opposite to the ejection base 3211. The first guide shaft 3221 passes through the two first through holes 3214 of the first guide groove 3213. The first block 3220 defines the sliding of the first body 3210 along a first direction in conjunction with the first guide groove 3213. The first spring 3230 provides the first body 3210 a restoring force along the first direction. The ejection base 3211 is collimated with the insert opening, and the first direction is substantially the same with the direction of insertion. The schematic top view of the present device after assembled is shown in FIG. 3A.

Referring to FIG. 6, which is an exploded perspective view of the second assembling component 3300. The second assembling component 3300 includes a second body 3310, a second block 3320 and a second spring 3330.

A second guide groove 3313 is formed inside the second body 3310. Two second through holes 3314 are provided with the guide groove 3313 and a right end of the second body 3310 is provided with a press-button 3340 exposed outside the casing of the testing unit 2000. A second slanted portion 3315 is provided on a left side of the second body 3310 relative to the first slanted portion 3215 of the first body 3210. A second guide shaft passes through an approximate middle portion of the second block 3320 disposed inside the second guide groove 3313 of the second body 3310. Two sides of the second block 3320 are provided with a second wing 3322, respectively, which is fixed on the circuit board of the testing unit 2000. A second spring 3330 envelopes one end of the second guide shaft 3321 approximate to the press-button 3340, and the second guide shaft 3321 passes through the two second through holes 3314 and the second guide groove 3313. In conjunction with the second guide groove 3313, the second block 3320 defines the sliding of the second body 3310 along the second direction. The second spring 3330 provides the second body 3310 a restoring force along the second direction.

The first slanted portion 3215 of the first assembling component 3200 abuts against the second slanted portion 3315 of the second assembling component 3300. Given the interaction of the first assembling component 3200 and the second assembling component 3300, an angle is contained between the first direction and the second direction such that through the first slanted portion 3215 and the second slanted portion 3315, an applied force from the second assembling component 3300 is conducted to the first assembling component 3200, thereby ejecting the test strip. Please refer to FIGS. 3A and 3B, when users press the press-button 3340, the second assembling component 3300 moves toward left, because the second block 3320 is fixed on the circuit board inside the testing unit 2000, the second assembling component 3300 slides along the second guide shaft 3321 and compresses the second spring 3330 on the second guide shaft 3321. The second slanted portion 3315 pushes the first slanted portion 3215, thereby driving the first assembling component 3200. The first slanted portion 3215 and the second slanted portion 3315 move along their respective oblique planes. Because the first block 3220 is fixed, the first assembling component 3200 moves along the first guide shaft 3221 to push the first spring 3230 and moves the ejection base 3211 forward such that the top abutting portions 3212 eject the test strip 1000 attached to the connector 2100. After ejecting the test strip, the first spring 3230 and the second spring 3330 restore the first assembling component 3200 and the second assembling component 3300 to their respective initial locations.

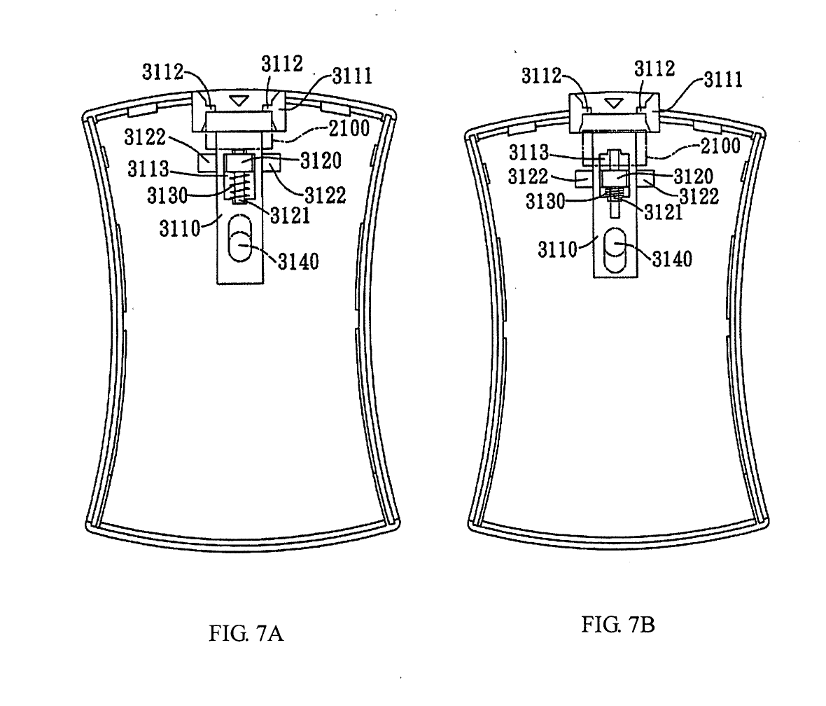

FIG. 7A is a schematic top view illustrating a device with a test strip-ejecting mechanism according to another embodiment of the present invention. FIG. 7B is a schematic top view illustrating the action of the device of FIG. 7A, in which the test strip 1000 is ejected through the movement of the body 3110. The difference between the device of FIG. 7A and the device of FIG. 3A is there is no force-transferring mechanism in the device of FIG. 7A.

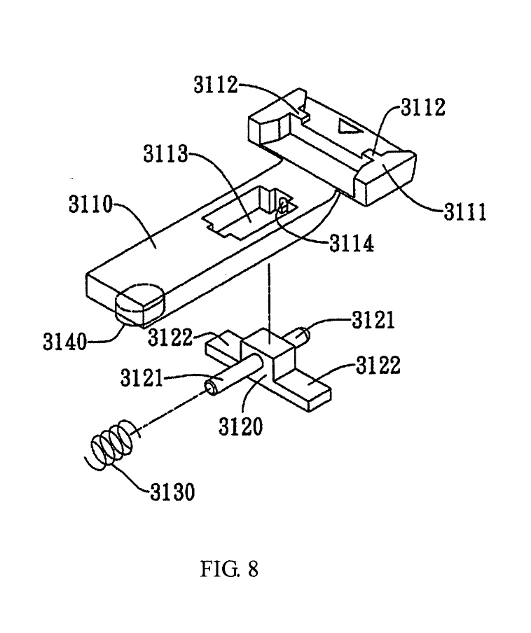

Referring to FIG. 8, which shows a schematic exploded view of the test strip-ejecting mechanism of the device of FIG. 7A, and the test-ejecting mechanism includes a body 3110, a block 3120 and a spring 3130.

A guide groove 3113 is formed inside the body 3110. Two through holes 3114 are formed with the guide groove 3113. A front end of the body 3110 is provided with an ejection base 3111. A press-button 3140 exposed outside the casing is formed on a backside of the body 3110 opposite to the end of the ejection base 3111. The ejection base 3111 is provided with a pair of top abutting portions 3112 so as to abut against the test strip 1000. The block 3120 is disposed in the guide groove 3113 inside the body 3110. A guide shaft 3121 passes through the block 3120. A pair of wings 3122, secured to a circuit board inside a testing unit 2000, is formed on two sides of the block 3120, respectively. A spring 3130 envelops another end of the guide shaft 3121 opposite to the ejection base 3111, and the guide shaft 3121 passes through the two through holes 3114 of the guide groove 3113. In conjunction with the guide groove 3113, the block 3120 defines the sliding of the body 3110 along a predetermined direction. The spring 3130 provides the body 3110 a restoring force along a predetermined direction. The ejection base 3111 is disposed at a direction of insertion of a test strip 1000 and the direction of insertion is substantially the same with the predetermined direction.

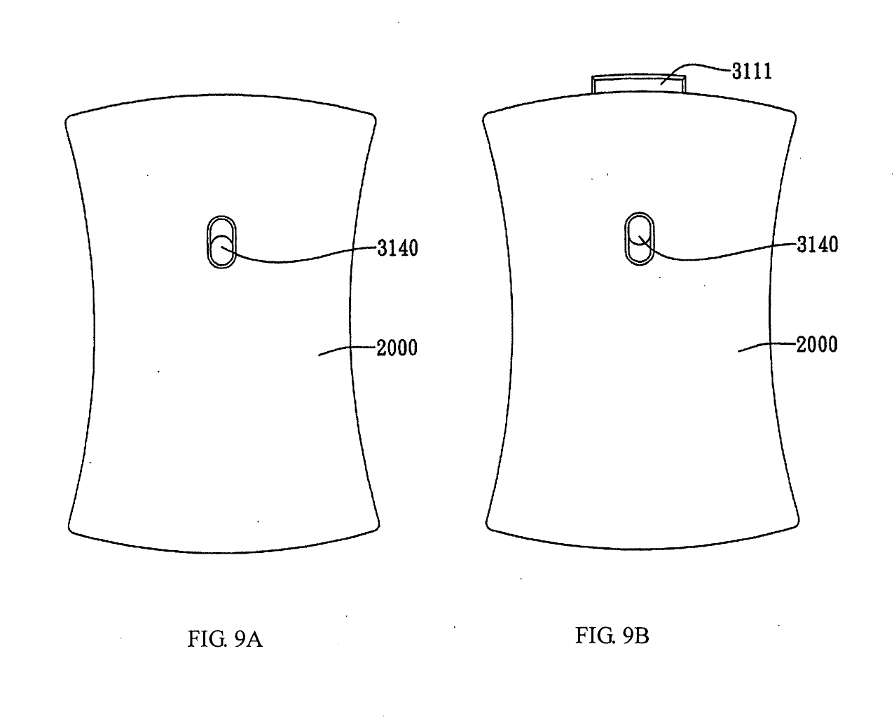

Referring to FIGS. 9A and 9B, which show schematic backside views of FIG. 7A and FIG. 7B, when users press the press-button 3140, the body 3110 moves forward. Because the block 3120 fixed on the testing unit 2000 does not move, the body 3110 slides along the guide shaft 3121 and compresses the spring 3130 along the guide shaft 3121, thereby ejecting the test strip through the top abutting portions 3112. After ejecting test strip 1000, the spring 3130 restores the body 3110 to its initial location.

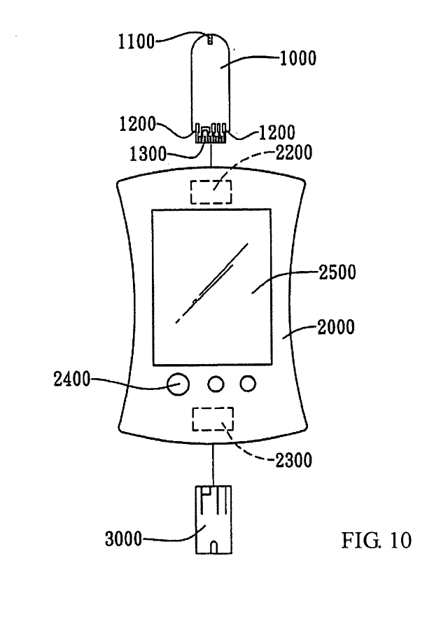

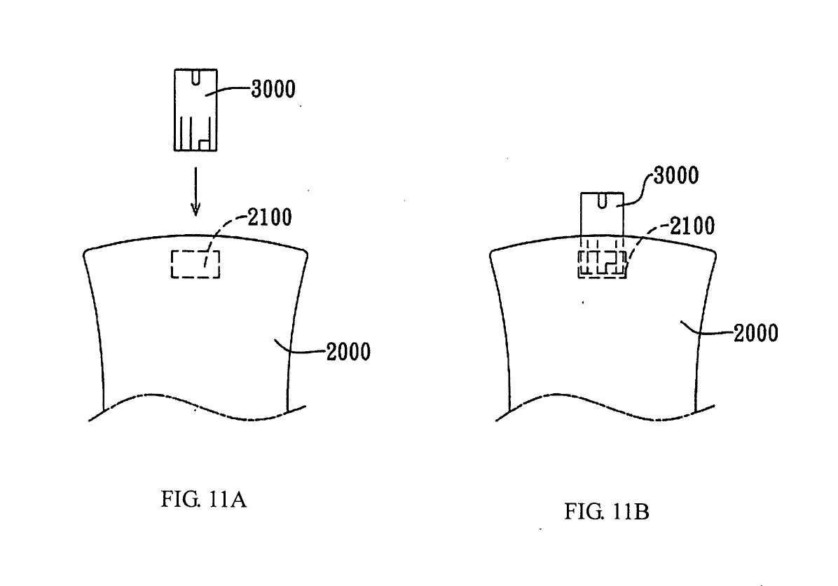

Referring to FIG. 10, which is a schematic top view of a device with a test strip-ejecting mechanism according to another embodiment of the present invention. The present invention provides a testing unit 2000 with a plurality of buttons 2400 and a display 2500 on a front side of the testing unit 2000 for operating the testing unit 2000 and observing testing results. A first connector 2200, a second connector 2300 and an operating unit are formed inside the testing unit 2000. The first connector 2200 is associated with the test strip-ejecting mechanism shown in FIG. 3A or FIG. 7A and suitable for the test strip 1000, while the second connector 2300 is suitable for the known test strip 3000, as shown in FIG. 10.

The present invention also provides a test strip-ejecting method, including the steps of: forming an insert opening in a casing of a testing unit 2000 and inserting a test strip 1000 into the insert opening; forming a slidable first body 3210 inside the casing such that the first body 3210 slides along a first direction and providing a restoring force to the first body 3210 along the first direction; and forming a slidable second body 3310 inside the casing of the testing unit 2000 such that the second body 3310 slides along a second direction and providing a restoring force to the second body 3310 along the second direction.

Given the coupling of the first body 3210 and the second body 3310, a 90-degree angle is contained between the first direction and the second direction. An ejection base 3211 extends from the first body 3210 and a pair of top abutting portions 3212 is formed with the ejection base 3211. The ejection base 3211 is collimated with the insert opening from which the test strip 1000 is ejected. The second body 3310 includes a press-button 3340.

The test strip-ejecting method according to another embodiment of the present device includes the steps of: forming an insert opening in a casing of a testing unit 2000 and inserting a test strip 1000 into the insert opening; forming a slidable body 3110 inside the casing of the testing unit 2000; extending an ejection base 3111 and a press-button 3140 from the body 3110 such that the ejection base 3111 is formed on a direction of insertion of the test strip 1000 and the press-button 3140 is exposed outside the casing; and providing the body 3110 a restoring force along the direction of insertion such that the ejection base 3111 ejects the test strip 1000 from the insert opening along the direction of insertion

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device with a test strip-ejecting mechanism, comprising:
a casing provided with an insert opening, which is collimated with a connector inside said casing for receiving a test strip; and
a test strip-ejecting mechanism installed inside said casing, comprising:
a first assembling component, including a first body, a first block and a first spring, said first body provided with a first guide groove, a front end of said first body having an ejection base, and said first body having a first slanted portion, wherein said first block is disposed in said first guide groove inside said casing to define said first body to slide along a first direction in conjunction with said first guide groove, said first spring provides said first body a restoring force along said first direction; and
a second assembling component, including a second body, a second block and a second spring, said second body provided with a second guide groove, a front end of said second body having a press-button outside said casing, and said second body having a second slanted portion, wherein said second block is disposed in said second guide groove inside said casing to define said second body to slide along a second direction in conjunction with said second guide groove, said second spring provides said second body a restoring force along said second direction, wherein said first slanted portion abuts against said second slanted portion such that an angle is contained between said first direction and said second direction.

2. The device with a test strip-ejecting mechanism as claimed in claim 1, wherein said ejection base has a pair of top abutting portions.

3. The device with a test strip-ejecting mechanism as claimed in claim 1, wherein said first guide groove is provided with first through holes, and said first block is provided with a first guide shaft passing said first through holes of said first guide groove, said first spring is disposed on said first guide shaft at a side of said first block.

4. The device with a test strip-ejecting mechanism as claimed in claim 1, wherein said second guide groove is provided with second through holes, and said second block is provided with a second guide shaft passing said second through holes of said second guide groove, said second spring is disposed on said second guide shaft at a side of said second block.

5. A test strip-ejecting mechanism, comprising:
a first assembling component, including a first body, a first block and a first spring, said first body provided with a first guide groove, a front end of said first body having an ejection base, and said first body having a first slanted portion, wherein said first block defines said first body to slide along a first direction in conjunction with said first guide groove, said first spring provides said first body a restoring force along said first direction;
a second assembling component, including a second body, a second block and a second spring, said second body provided with a second guide groove, a front end of said second body having a press-button outside said casing, and said second body having a second slanted portion, wherein said second block defines said second body to slide along a second direction in conjunction with said second guide groove, said second spring provides said second body a restoring force along said second direction, said first slanted portion abuts against said second slanted portion such that an angle is contained between said first direction and said second direction; and
wherein said ejection base ejects a test strip from a connector when said first assembling component interacts with said second assembling component.

6. The test strip-ejecting mechanism as claimed in claim 5, wherein said ejection base includes a pair of top abutting portions.

7. The test strip-ejecting mechanism as claimed in claim 5, wherein said first guide groove is provided with first through holes, and said first block is provided with a first guide shaft passing said first through holes of said first guide groove, said first spring is disposed on said first guide shaft at a side of said first block.

8. The test strip-ejecting mechanism as claimed in claim 5, wherein said second guide groove is provided with second through holes, and said second block is provided with a second guide shaft passing said second through holes of said second guide groove, said second spring is disposed on said second guide shaft at a side of said second block.

9. A device with a test strip-ejecting mechanism, comprising:
a casing, provided with an insert opening, which is collimated with a connector inside said casing for receiving a test strip; and
a test strip-ejecting mechanism, installed inside said casing, comprising:
a body, provided with a guide groove and having an ejection base formed on a front end of said body;
a block, disposed inside said casing to define said body to slide along a predetermined direction in conjunction with said guide groove; and
a spring, providing said body a restoring force along said predetermined direction.

10. The device with a test strip-ejecting mechanism as claimed in claim 9, wherein said ejection base includes a pair of top abutting portions.

11. The device with a test strip-ejecting mechanism as claimed in claim 9, wherein said body comprises a press-button.

12. The device with a test strip-ejecting mechanism as claimed in claim 9, wherein said guide groove is provided with through holes, said block is provided with a first guide shaft passing said through holes of said guide groove, and said spring is disposed on said first guide shaft at a side of said block.
